(19) United States
(12) Patent Application Publication
(10) Pub. No.: US 2018/0077065 A1
(43) Pub. Date: Mar. 15, 2018

(54) TRANSMITTING PACKET

(71) Applicant: Hangzhou DPtech Technologies Co., Ltd., Zhejiang Province (CN)

(72) Inventor: Qingsong TANG, Zhejiang Province (CN)

(73) Assignee: Hangzhou DPtech Technologies Co., Ltd., Zhejiang Province (CN)

(21) Appl. No.: 15/701,772

(22) Filed: Sep. 12, 2017

(30) Foreign Application Priority Data
Sep. 13, 2016 (CN) 201610822545.X

(51) Int. Cl. H04L 12/851; H04L 29/08; H04L 29/06

(52) U.S. Cl. CPC H04L 47/24; H04L 67/02; H04L 63/1408; H04L 69/22; H04L 63/0245; H04L 67/42; H04L 63/0218

(57) ABSTRACT

A network protection equipment (NPE) and a method of transmitting a packet are provided. According to an example of the method, when receiving an HTTP request packet from a client, the NPE may restrict a transmission manner of an HTTP response packet corresponding to the HTTP request packet as a chunked transmission manner. Where, the HTTP response packet is a packet returned to the NPE by a server in response to the HTTP request packet. The NPE may determine whether a redirection packet is to be established for the HTTP response packet based on the HTTP response packet and a preset detection condition. When determining that a redirection packet for the HTTP response packet is to be established, the NPE may establish a redirection packet for the HTTP response packet based on the HTTP response packet and send the redirection packet to the client in the chunked transmission manner.

### CROSS REFERENCE TO RELATED APPLICATIONS

This application claims priority to Chinese Patent Application No. 201610822545.X entitled “Method of transmitting packet and device thereof” filed on Sep. 13, 2016, the entire content of which is incorporated herein by reference.

### TECHNICAL FIELD

The present disclosure relates to transmitting a network communication packet.

### BACKGROUND

With the rapid development of the Internet data communication technology, a user pays more and more attention to the security issue of a webpage. In general, a network protection equipment (NPE) deployed between a client and a server is used to detect whether a HyperText Transfer Protocol (HTTP) response packet is abnormal. When detecting that the HTTP response packet is abnormal, the NPE sends a redirection packet to a client.

An NPE may transmit an HTTP response packet in a segmented transmission manner, where the HTTP response packet specifies a data size of a subsequent packet. Therefore, when the size of a redirection packet exceeds the size specified by the HTTP response packet for a subsequent packet, over many data may not be transmitted normally by the NPE, thereby causing the client unable to perform normal redirection.

### SUMMARY

Based on this, the present disclosure provides an NPE and a method of transmitting a packet so as to solve the problem that a client cannot perform normal redirection.

To achieve the above objective, the present disclosure provides the following technical solution.

A method of transmitting a packet is provided according to a first aspect of the present disclosure, which is applied to an NPE and includes:
receiving, by an NPE, an HTTP request packet from a client;
restricting, by the NPE, a transmission manner of an HTTP response packet corresponding to the HTTP request packet as a chunked transmission manner, where the HTTP response packet is a packet returned to the NPE by a server in response to the HTTP request packet;
determining, by the NPE, whether a redirection packet is to be established for the HTTP response packet based on the HTTP response packet and a preset detection condition;
establishing, by the NPE, a redirection packet corresponding to the HTTP response packet based on the HTTP response packet when the NPE determines that a redirection packet is to be established for the HTTP response packet; and
sending, by the NPE, the redirection packet to the client in the chunked transmission manner.

An NPE is provided according to a second aspect of the present disclosure, which includes a processor, where the processor reads machine readable instructions corresponding to control logic of transmitting a packet and stored in a non-volatile memory and executes the instructions in a memory to:
receive an HTTP request packet from a client;
restrict a transmission manner of an HTTP response packet corresponding to the HTTP request packet as a chunked transmission manner, where the HTTP response packet is a packet returned to an NPE by a server in response to the HTTP request packet;
determine whether a redirection packet is to be established for the HTTP response packet based on the HTTP response packet and a preset detection condition;
establish a redirection packet corresponding to the HTTP response packet based on the HTTP response packet, when determining that a redirection packet is to be established for the HTTP response packet, and
send the redirection packet to the client in the chunked transmission manner.

It may be seen from the above technical solution that an NPE sends a redirection packet to a client in a chunked transmission manner; when the size of the redirection packet exceeds the size specified by the HTTP response packet for a subsequent packet, the NPE may still normally transmit the redirection packet to the client since the chunked transmission manner does not limit the size of the redirection packet.

### BRIEF DESCRIPTION OF DRAWINGS

FIG. 1 illustrates a schematic diagram of an application scenario of transmitting a packet according to an example of the present disclosure.

FIG. 2 illustrates a flow chart of a method of transmitting a packet according to an example of the present disclosure.

FIG. 3 illustrates a flow chart of a method of transmitting a packet according to another example of the present disclosure.

FIG. 4 illustrates a flow chart of a method of transmitting a packet according to still another example of the present disclosure.

FIG. 5 illustrates a hardware structure diagram of an NPE according to an example of the present disclosure.

FIG. 6 illustrates a block diagram of a functional module of control logic of transmitting a packet according to an example of the present disclosure.

FIG. 7 illustrates a block diagram of a functional module of control logic of transmitting a packet according to another example of the present disclosure.

FIG. 8 illustrates a block diagram of a functional module of control logic of transmitting a packet according to still another example of the present disclosure.

### DETAILED DESCRIPTION

Illustrative embodiments will be described here in detail with examples shown in the drawings. When the drawings are referred to in the description below, the same numeral in different drawings represents the same or similar element, unless otherwise stated. The implementations described in the embodiments below are not intended to represent all implementations consistent with the present disclosure. On the contrary, they are merely examples of device and method consistent with some aspects of the present disclosure as detailed in the claims.

The terms used in the present disclosure are only intended to describe particular embodiments rather than limit the present disclosure. Singular forms “a”, “said” and “the” used in the present disclosure and the claims are also intended to include plurals, unless otherwise indicated in the context. It also should be understood that the term “and/or” used in the text refers to and includes any or all possible combinations of one or more associated items listed.

It should be understood that although the terms such as first, second and third may be adopted in the present disclosure to describe different information, these information should not be limited to these terms. These terms are only used for differentiating information of the same type. For example, without departing from the scope of the present disclosure, the first information also may be referred to as the second information, and similarly, the second information also may be referred to as the first information. That depends on the context. For example, the term ‘if’ used here may be interpreted as “when . . . ” or “as” or “in response to determination . . . ”.

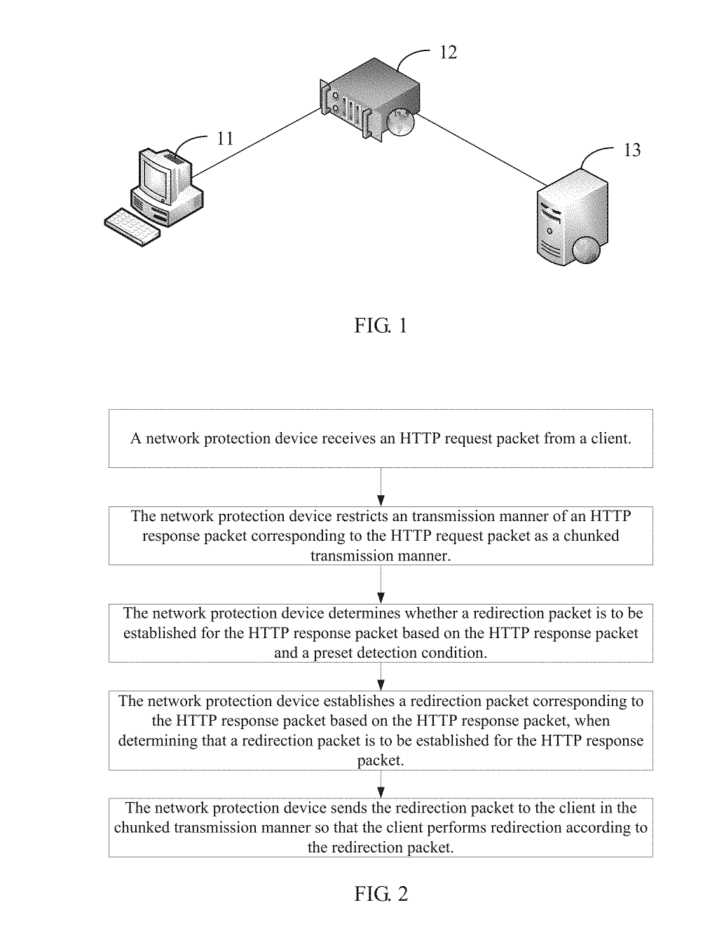

FIG. 1 illustrates a schematic diagram of an application scenario of transmitting a packet according to an example of the present disclosure. As shown in FIG. 1, a packet transmission system includes a client 11 installed on a Personal Computer (PC), a WEB application firewall 12 and a WEB server 13. The WEB application firewall 12 may be an NPE integrating WEB protection, webpage protection, load balancing and application delivery. It may be understood, by those skilled in the art, that the client 11, WEB application firewall 12 and WEB server 13 in the abovementioned packet transmission system are merely illustrative and should not constitute any limitation to the present disclosure. The client 11 may also be installed on a terminal device such as a mobile phone, a tablet computer and a smart watch. The WEB application firewall 12 may also be an NPE such as an Intrusion Prevention System (IPS) and a Unified Threat Management (UTM). The WEB server 13 may also be a device such as a FTP server and a database server. The WEB application firewall 12 may forward an HTTP request packet from the client 11 to the WEB server 13. When the WEB application firewall 12 receives an HTTP response packet returned by the WEB server 13 for the HTTP request packet, the WEB application firewall 12 restricts a transmission manner of the HTTP response packet as a chunked transmission manner. The WEB application firewall 12 performs anomaly detection on the HTTP response packet. When determining that the HTTP response packet is abnormal, the WEB application firewall 12 may establish a redirection packet for the HTTP response packet and send the redirection packet to a client in the chunked transmission manner so that the client 11 performs redirection according to the redirection packet. According to an example of the present disclosure, the WEB application firewall 12 may transmit a redirection packet to the client 11, no matter whether the size of the redirection packet exceeds the size specified by the HTTP response packet for a subsequent packet.

To further describe the present disclosure, the following examples are provided.

FIG. 2 illustrates a flow chart of a method of transmitting a packet according to an example of the present disclosure; the example of the present disclosure is illustrated with reference to FIG. 1 and FIG. 2; and as shown in FIG. 2, the method includes the following blocks.

At block 201: an NPE receives an HTTP request packet from a client.

At block 202: the NPE restricts a transmission manner of an HTTP response packet corresponding to the HTTP request packet as a chunked transmission manner, where the HTTP response packet is a packet returned to the NPE by a server in response to the HTTP request packet.

At block 203: the NPE determines whether a redirection packet is to be established for the HTTP response packet based on the HTTP response packet and a preset detection condition.

At block 204: the NPE establishes a redirection packet corresponding to the HTTP response packet based on the HTTP response packet, when determining that a redirection packet is to be established for the HTTP response packet.

At block 205: the NPE sends the redirection packet to the client in the chunked transmission manner so that the client performs redirection according to the redirection packet.

Illustrative description is made below according to FIG. 1, where a client is the client 11, an NPE is the WEB application firewall 12 and a server is the WEB server 13:

In an example, at block 201, the WEB application firewall 12 receives an HTTP request packet from the client 11.

In an example, at block 202, the WEB server 13 returns an HTTP response packet to the WEB application firewall 12 in response to the HTTP request packet, and the WEB application firewall 12 restricts a transmission manner of the HTTP response packet as a chunked transmission manner.

Table 1 below illustrates a schematic diagram of a structure of an HTTP request packet:

TABLE 1

| | | | | | | |
|---|---|---|---|---|---|---|
| Method of | SPACE | URI | SPACE | Protocol | Carriage | Line |
| Requesting | | Address | | Version | Return | Break |

| | | | | |
|---|---|---|---|---|
| Header Field | . | Value | Carriage | Line Break |
| Name | . | | Return | |
| | . | | | |

. . .

| | | | | |
|---|---|---|---|---|
| Header Field | . | Value | Carriage | Line Break |
| Name | . | | Return | |
| | . | | | |

| | |
|---|---|
| Carriage | Line Break |
| Return | |

Request Text

In Table 1, the first row is a request line; the second to the fourth row is a request header where the specific number of rows included in the request header is set by the client 11 according to different needs; and the sixth row is the text of request. When the WEB application firewall 12 receives an HTTP request packet from the client 11, the WEB application firewall 12 determines a first Uniform Resource Locator (URL) based on a Uniform Resource Identifier (URI) address in the HTTP request packet and a domain name in the header field name, where the process of determining the first URL may be any technology that is well known to those skilled in the art, which is thus not described in detail.

Table 2 below illustrates a schematic diagram of a structure of an HTTP response packet.

TABLE 2

| | | | | | | |
|---|---|---|---|---|---|---|
| Protocol | SPACE | Status | SPACE | Descrip- | Carriage | Line |
| Version | | Code | | tion of | Return | Break |
| | | | | Status | | |
| | | | | Code | | |

| | | | | |
|---|---|---|---|---|
| Header | . | Value | Carriage | Line Break |
| Field | . | | Return | |
| Name | . | | | |

. . .

| | | | | |
|---|---|---|---|---|
| Header | . | Value | Carriage | Line Break |
| Field | . | | Return | |
| Name | . | | | |

| | |
|---|---|
| Carriage | Line Break |
| Return | |

Response Text

In Table 2, the first row is a status line; the second to the fourth row is a response header, and the number of rows included in the response header is set by the client 11 according to different needs; and the sixth row is the text of response. The response header is formed by pairs of “Header Field Name: Value” with one pair for one row, and the name and the value are separated by a colon. For example, the “Header Field Name: Value” may be “Content-Length: 500” or “Transfer-Encoding: chunked” where the Content-Length is a first field name, and the Transfer-Encoding is a second field name. The “Content-Length: 500” may indicate that the WEB application firewall 12 transmits an HTTP response packet in a segmented transmission manner of Content-Length, and the length of the HTTP response packet is 500 bytes. “Transfer-Encoding: chunked” may indicate that the WEB application firewall 12 transmits an HTTP response packet in a transmission manner of Transfer-Encoding, and a value corresponding to the transmission manner is chunked. The segmented transmission manner and the chunked transmission manner cannot exist in the same HTTP response packet at the same time.

It may be understood, by those skilled in the art, that Table 1 and Table 2 are described here to help those skilled in the art to better understand the examples of the present disclosure, and the Table 1 and Table 2 are only illustrative and cannot constitute any limitation to the present disclosure.

In an example, at block 203, the WEB application firewall 12 acquires a detection condition list. The detection condition list may be a list established by the WEB application firewall 12 or a list established and then sent by the client 11 to the WEB application firewall 12. The detection condition list may be shown in Table 3, and a list containing 2 preset detection conditions is described as an example:

TABLE 3

| Sequence Number | Preset Detection Condition |
|---|---|
| 1 | Trojan |
| 2 | >512 Bytes |

In Table 3, the preset detection condition included in the detection condition list may comprise a string of characters or a threshold of a packet size, etc. The WEB application firewall 12 may compare an HTTP response packet with preset detection conditions in the detection condition list. For example, a preset detection condition is “Trojan”. When an HTTP response packet has the character of “Trojan”, the HTTP response packet matches the preset detection condition recorded in the detection condition list and thus is determined as abnormal. In this case, a redirection packet is to be established for the HTTP response packet.

At block 204, when the HTTP response packet matches a preset detection condition in the detection condition list in the WEB application firewall 12, the HTTP response packet is determined as abnormal, and the WEB application firewall 12 determines that a redirection packet is to be established for the HTTP response packet, and establishes a redirection packet corresponding to the HTTP response packet based on the HTTP response packet.

In an example, the WEB application firewall 12 sends a redirection packet to the client 11 in the chunked transmission manner at block 205 so that the client 11 performs redirection according to the redirection packet.

In an example of the present disclosure, an NPE sends a redirection packet to a client in the chunked transmission manner; even though the size of the redirection packet exceeds the size specified by the HTTP response packet for a subsequent packet, the NPE still may normally transmit the redirection packet to the client since the chunked transmission manner does not limit the size of the redirection packet.

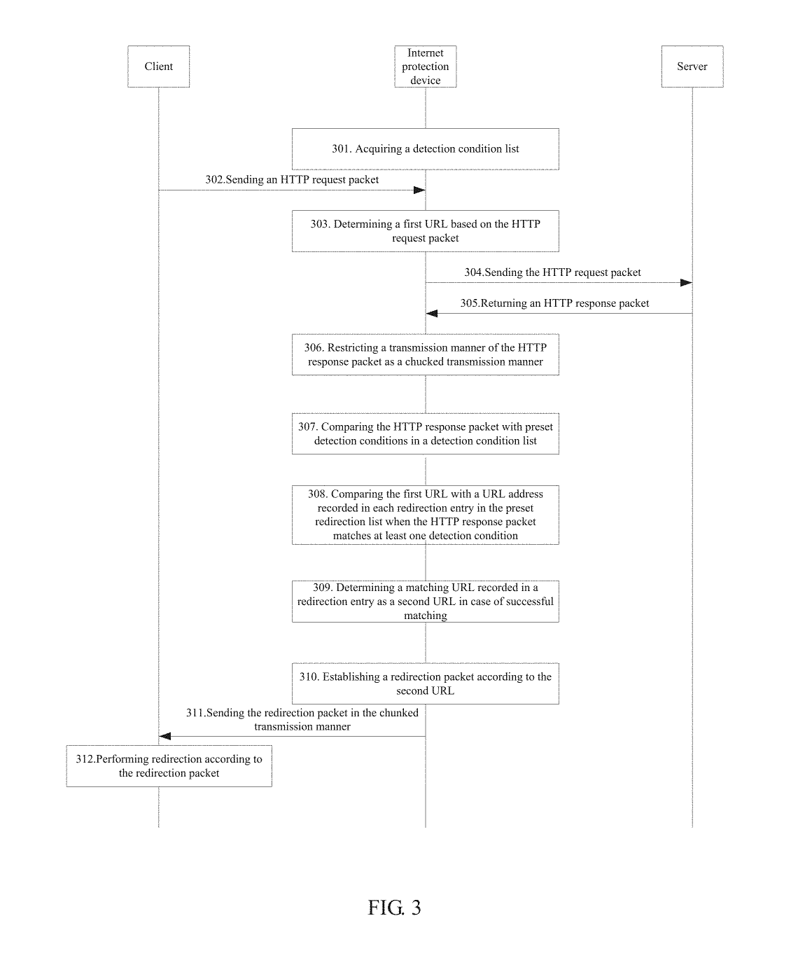

FIG. 3 illustrates a flow chart of a method of transmitting a packet according to another example of the present disclosure. The example of the present disclosure is illustrated with reference to FIG. 1 and FIG. 2. As shown in FIG. 3, the method includes the following blocks.

At block 301: an NPE acquires a detection condition list, where the detection condition list may include one or more preset detection conditions, and each of the preset detection conditions may comprise a threshold of a packet size or a string of characters.

At block 302: a client sends an HTTP request packet to the NPE.

At block 303: the NPE determines a first URL based on the HTTP request packet.

At block 304: the NPE sends the HTTP request packet to a server.

At block 305: the server returns an HTTP response packet to the NPE in response to the HTTP request packet.

At block 306: the NPE restricts a transmission manner of the HTTP response packet as a chunked transmission manner.

At block 307: the NPE compares the HTTP response packet with preset detection conditions in the detection condition list in the NPE to determine whether a redirection packet is to be established for the HTTP response packet.

At block 308: the NPE determines that a redirection packet is to be established for the HTTP response packet and compares the first URL with a URL address recorded in each redirection entry in the preset redirection list when the HTTP response packet matches at least one of the detection conditions.

At block 309: the NPE determines a matching URL address recorded in a redirection entry as a second URL when the first URL matches the URL address recorded in the redirection entry in the preset redirection list.

At block 310: the NPE establishes a redirection packet according to the second URL.

At block 311: the NPE sends the redirection packet to the client in the chunked transmission manner.

At block 312: the client performs redirection according to the redirection packet.

Illustrative description is made below according to FIG. 1, where a client is the client 11, an NPE is the WEB application firewall 12 and a server is the WEB server 13.

At block 301, the WEB application firewall 12 acquires a detection condition list, where the detection condition list may include one or more preset detection conditions, and each of the preset detection conditions may comprise a threshold of a packet size or a string of characters, for example, “Trojan” and “512 bytes”.

It may be understood, by those skilled in the art, that the block 301 and the blocks 302-306 do not have a precedence relationship of time sequence. The block 301 may be executed at any block prior to the execution of the block 307.

At block 302, the client 11 sends an HTTP request packet to the WEB application firewall 12.

At block 303, the WEB application firewall 12 determines a first URL based on the HTTP request packet. For example, the first URL may be http://www.sohu.com/domain/HXWZ.

At block 304, the WEB application firewall 12 sends the HTTP request packet to the WEB server 13.

At block 305, the WEB server 13 returns an HTTP response packet to the WEB application firewall 12 in response to the HTTP request packet.

At block 306, in an example, the WEB application firewall 12 restricts a transmission manner of the HTTP response packet as a chunked transmission manner. The WEB application firewall 12 searches a header field name in a response header of the HTTP response packet for a first field name. If the first field name is found, the WEB application firewall 12 changes the first field name in the header field name into a second field name and changes the value corresponding to the header field name into a value corresponding to the second field name. Specifically, the WEB application firewall 12 searches the header field name in the HTTP response packet for Content-Length. If Content-Length is found, the WEB application firewall 12 will change the header field name into Transfer-Encoding and change the value corresponding to the header field name into chunked.

Optionally, when the first field name is not found in the header field name in the response header of the HTTP response packet, the WEB application firewall 12 searches the header field name in the response header of the HTTP response packet for a second field name. If the second field name is found, the WEB application firewall 12 restricts a transmission manner of the HTTP response packet as a chunked transmission manner. Specifically, when Content-Length is not found in the header field name, the WEB application firewall 12 searches the header field name in the response header of the HTTP response packet for Transfer-Encoding. If Transfer-Encoding is found, the WEB application firewall 12 restricts a transmission manner of the HTTP response packet as a chunked transmission manner.

At block 307, in an example, the WEB application firewall 12 compares the HTTP response packet with preset detection conditions in the detection condition list. If the HTTP response packet matches at least one of the preset detection conditions, the WEB application firewall 12 determines that a redirection packet is to be established for the HTTP response packet; otherwise, it indicates that it is not necessary to establish a redirection packet for the HTTP response packet.

At block 308, when the HTTP response packet matches at least one of the preset detection conditions in the detection condition list in the WEB application firewall 12, the WEB application firewall 12 compares the first URL with a preset redirection list in the WEB application firewall 12 where a plurality of redirection entries may be recorded in the preset redirection list and a corresponding relationship of a group of URL addresses may be recorded in each redirection entry. For example, a determining condition set by a preset detection condition in the detection condition list in the WEB application firewall 12 is “Trojan”. If the HTTP response packet has a character of “Trojan”, the HTTP response packet matches the “Trojan” in the entry, and the WEB application firewall 12 determines that a redirection packet is to be established for the HTTP response packet. If a corresponding relationship between http://www.sohu.com/domain/HXWZ and http://www.sohu.com is recorded in a redirection entry in a preset redirection list in WEB server 13, the WEB application firewall 12 matches the http://www.sohu.com/domain/HXWZ with the redirection entry in the redirection list.

At block 309, when the first URL matches a URL address recorded in a redirection entry in the preset redirection list, the WEB application firewall 12 determines the matching URL address recorded in the redirection entry as a second URL. For example, the http://www.sohu.com is determined as a second URL according to block 308.

At block 310, the WEB application firewall 12 establishes a redirection packet according to the second URL. Here, a method of establishing a redirection packet by the WEB application firewall 12 according to the second URL may be any technology well known to those skilled in the art, which is not described again in detail.

At block 311, the WEB application firewall 12 sends the redirection packet to the client 11 in the chunked transmission manner.

At block 312, the client 11 performs redirection according to the redirection packet. Here, a method of performing redirection by the client 11 according to the redirection packet may be any technology well known to those skilled in the art, which is not described again in detail.

In an example of the present disclosure, the WEB application firewall 12 sends the redirection packet to the client 11 in the chunked transmission manner so as to ensure that the redirection packet is transmitted to the client 11.

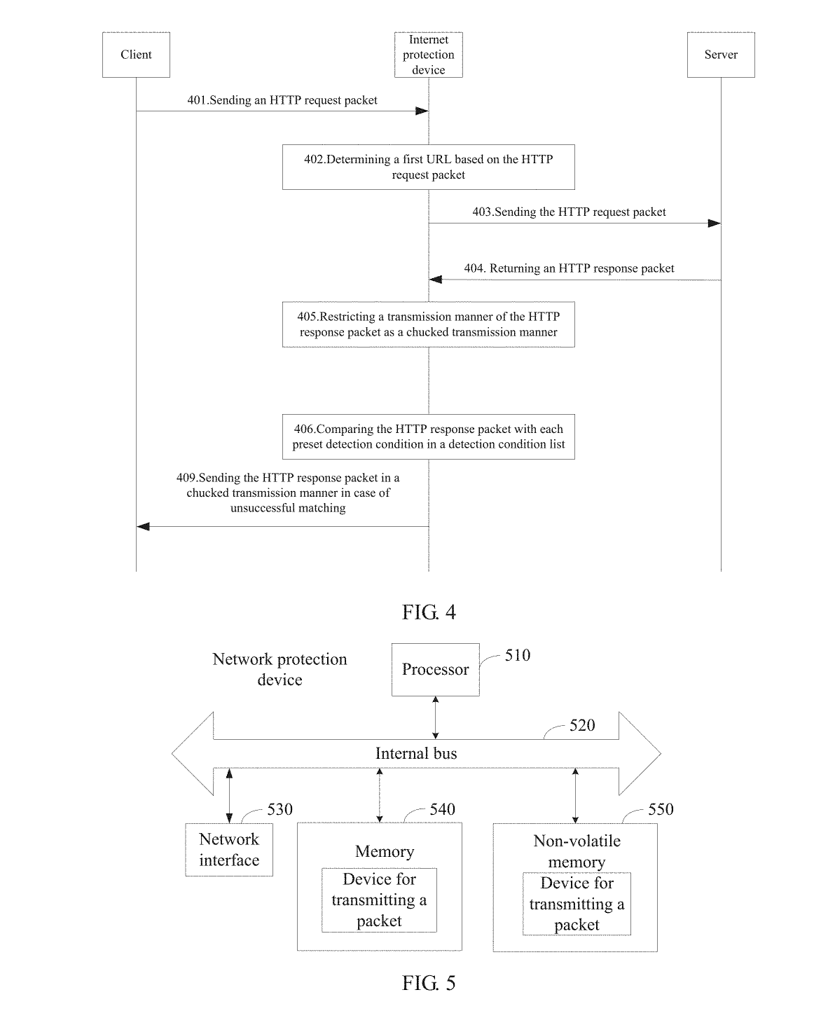

FIG. 4 illustrates a flow chart of a method of transmitting a packet according to still another example of the present disclosure. The example of the present disclosure is illustrated with reference to FIG. 1. FIG. 2 and FIG. 3; and as shown in FIG. 4, the method includes the following blocks.

At block 401: a client sends an HTTP request packet to an NPE.

At block 402: the NPE determines a first URL based on the HTTP request packet.

At block 403: the NPE sends the HTTP request packet to a server.

At block 404: the server returns an HTTP response packet to the NPE in response to the HTTP request packet.

At block 405: the NPE restricts a transmission manner of the HTTP response packet as a chunked transmission manner.

At block 406: the NPE compares the HTTP response packet with preset detection conditions in a detection condition list in the NPE.

At block 407: the NPE determines that it is not necessary to establish a redirection packet for the HTTP response packet, and sends the HTTP response packet to the client in the chunked transmission manner when the HTTP response packet does not match any preset detection condition.

Illustrative description is made below with reference to FIG. 1, where a client is the client 11, an NPE is the WEB application firewall 12 and a server is the WEB server 13:

Blocks 401-406 may be referred to related descriptions of blocks 302-307 shown in FIG. 3, which are not described in detail here.

At block 407, when the HTTP response packet does not match any preset detection condition in the detection condition list in the WEB application firewall 12, it indicates that the HTTP response packet does not have any anomaly, and the WEB application firewall 12 determines that it is not necessary to establish a redirection packet for the HTTP response packet. The WEB application firewall 12 sends the HTTP response packet to the client 11 in the chunked transmission manner.

In an example of the present disclosure, the WEB application firewall 12 restricts a transmission manner of the HTTP response packet as a chunked transmission manner and sends the HTTP response packet to the client 11 in the chunked transmission manner; and even though a data length specified by the HTTP response packet for a subsequent packet is less than an actual length of the HTTP response packet, the client 11 may still receive the HTTP response packet normally.

Correspondingly to the abovementioned method of transmitting a packet, the present disclosure also provides a hardware structure diagram of an NPE shown in FIG. 5. As shown in FIG. 5, the NPE may include a processor 510, an internal bus 520, a network interface 530, a memory 540 and a non-volatile memory 550 at a hardware level. The NPE may also include hardware required by other services. The processor 510 reads corresponding computer program from the non-volatile memory 550 into the memory 540 and then runs the computer program to logically form a device for transmitting a packet. Of course, in addition to a software implementation, the present disclosure does not preclude other implementations, for example, implementation by a logic device or a combination of software and hardware etc. It is to say that an executive subject of the processing flow below is not limited to each logic unit and the executive subject may also be a hardware or logic device.

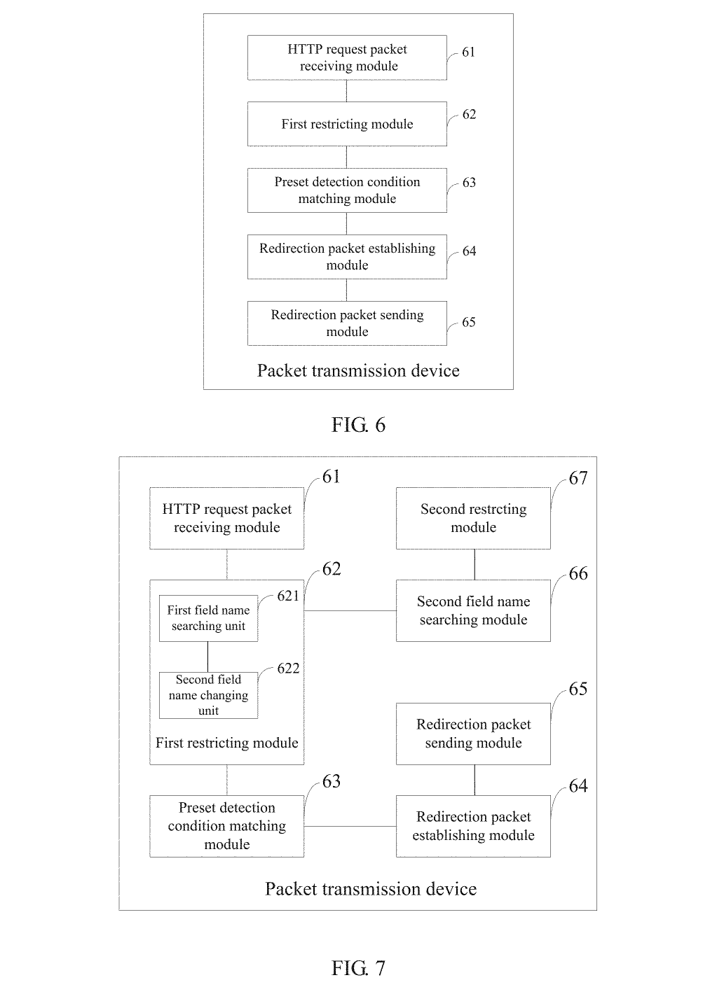

FIG. 6 illustrates a block diagram of a functional module of control logic of transmitting a packet according to an example of the present disclosure. As shown in FIG. 6, the control logic of transmitting a packet may functionally include an HTTP request packet receiving module 61, a first restricting module 62, a preset detection condition matching module 63, a redirection packet establishing module 64 and a redirection packet sending module 65.

The HTTP request packet receiving module 61 is configured to receive an HTTP request packet from a client.

The first restricting module 62 is configured to restrict a transmission manner of an HTTP response packet corresponding to the HTTP request packet received by the HTTP request packet receiving module 61 as a chunked transmission manner, where the HTTP response packet is a packet returned by a server to the NPE in response to the HTTP request packet.

The preset detection condition matching module 63 is configured to determine whether a redirection packet is to be established for the HTTP response packet, based on the HTTP response packet in the first restricting module 62 and a preset detection condition.

The redirection packet establishing module 64 is configured to establish a redirection packet corresponding to the HTTP response packet based on the HTTP response packet when the preset detection condition matching module 63 determines that a redirection packet is to be established for the HTTP response packet in the first restricting module 62.

The redirection packet sending module 65 is configured to send the redirection packet established in the redirection packet establishing module 64 to a client in a chunked transmission manner so that the client performs redirection according to the redirection packet.

FIG. 7 illustrates a block diagram of a functional module of control logic of transmitting a packet according to another example of the present disclosure. As shown in FIG. 7, based on the example shown in the above FIG. 6, the first restricting module 62 may include:
a first field name searching unit 621, which is configured to search a header field name in a response header of the HTTP response packet in the first restricting module 62 for a first field name; and
a second field name changing unit 622, which is configured to change the first field name in the header field name into a second field name and change the value corresponding to the header field name into a value corresponding to the second field name when the first field name in the first field name searching unit 621 is found in the header field name in the response header of the HTTP response packet in the first restricting module 62.

In an example, the control logic of transmitting a packet may further logically include:
a second field name searching module 66, which is configured to search the header field name in the response header for a second field name in the second field name changing unit 622 when the first field name in the first field name searching unit 621 is not found in the header field name in the response header of the HTTP response packet in the first restricting module 62; and
a second restricting module 67, which is configured to restrict a transmission manner of the HTTP response packet as a chunked transmission manner when the second field name is found in the header field name in the response header of the HTTP response packet.

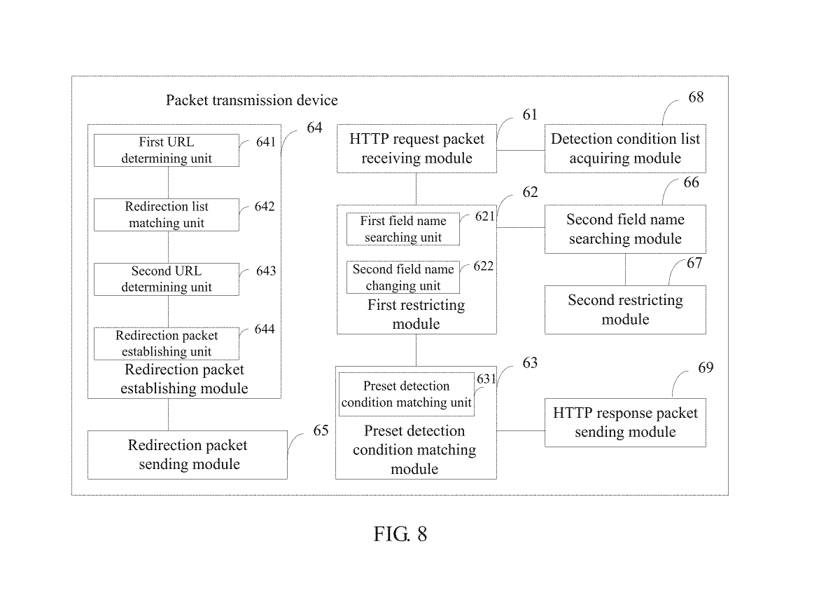

FIG. 8 illustrates a block diagram of a functional module of control logic of transmitting a packet according to still another example of the present disclosure. As shown in FIG. 8, based on the example shown in the above FIG. 7, the control logic of transmitting a packet may also include:
a detection condition list acquiring module 68, which is configured to acquire a detection condition list, where the detection condition list includes one or more preset detection conditions in the preset detection condition matching module 63, and each of the preset detection conditions may comprise a threshold of a packet size or a string of characters.

In an example, the preset detection condition matching module 63 may include:
a preset detection condition matching unit 631, which is configured to compare an HTTP response packet in the first restricting module 62 with preset detection conditions in a detection condition list acquired by the detection condition list acquiring module 68, and determine that a redirection packet is to be established for the HTTP response packet if the HTTP response packet matches at least one of the preset detection conditions, and otherwise, determine it is not necessary to establish a redirection packet for the HTTP response packet.

In an example, the control logic of transmitting a packet may also include:
an HTTP response packet sending module 69, which is configured to send the HTTP response packet to a client in a chunked transmission manner, when the preset detection condition matching module 63 determines that it is not necessary to establish a redirection packet for the HTTP response packet.

In an example, the redirection packet establishing module 64 may include:
a first URL determining unit 641, which is configured to determine a first URL based on an HTTP request packet when the preset detection condition matching module 63 determines that a redirection packet is to be established for the HTTP response packet, where the first URL is a URL address determined based on the HTTP request packet when the HTTP request packet is received from the client;
a redirection list matching unit 642, which is configured to compare the first URL determined by the first URL determining unit 641 with a URL address recorded in each redirection entry in a preset redirection list;
a second URL determining unit 643, which is configured to determine a matching URL address recorded in a redirection entry as a second URL when the first URL in the redirection list matching unit 642 matches the URL address recorded in a redirection entry in the preset redirection list; and
a redirection packet establishing unit 644, which is configured to establish a redirection packet according to the second URL determined by the second URL determining unit 643.

The specific implementation process of the functions and effects of each unit in the abovementioned device may be referred to the implementation process of corresponding blocks in the abovementioned method, which is not described here.

For device examples, since examples of the device basically correspond to examples of the method, the related parts may be referred to descriptions of the embodiments of the method. The embodiments of the device described above are merely illustrative, where the unit described as a separate component may be or may not be physically separated, and a component displayed as a unit may be or may not be a physical unit, for example, it may be located in a place or distributed on a plurality of network units. Some or all modules therein may be selected according to actual needs to achieve the objective of the solution of the present disclosure. Those of ordinary skill in the art may understand and implement the solution without creative work.

It may be seen from the abovementioned embodiments that an NPE sends a redirection packet to a client in a chunked transmission manner. When the size of the redirection packet exceeds the size specified by an HTTP response packet for a subsequent packet, the NPE may normally transmit the redirection packet to the client since the chunked transmission manner does not limit the size of the redirection packet.

Other implementations may easily occur to those skilled in the art after considering the specification and practicing the present disclosure. The present disclosure aims to cover any modification, application or adaptive change of the present disclosure which conform to general principles of the present disclosure and include the common general knowledge or conventional technological means in the art unrevealed in the present disclosure. The specification and embodiments are only illustrative; and the real scope and spirits of the present disclosure are stated by the claims below.

It also should be noted that the terms “comprising” and “including”, or any other variants thereof are intended to be non-exclusive, such that a process, a method, an article or a device comprising a series of elements includes not only those elements, but also other elements not explicitly listed, or further includes inherent elements of the process, the method, the article or the device. Without more limitations, elements defined by the sentence of “comprising a . . . ” shall not be exclusive of additional same elements also existing in the process, the method, the article or the device including the elements.

The above description is merely preferred embodiments of the present disclosure and is not intended to limit the present disclosure. Any modification, equal replacement, improvement and the like made within the spirits and principles of the present disclosure should fall within the protection scope of the present disclosure.

1. A method of transmitting a packet, comprising:
receiving, by a network protection equipment (NPE), an HTTP request packet from a client;
restricting, by the NPE, a transmission manner of an HTTP response packet corresponding to the HTTP request packet as a chunked transmission manner, wherein the HTTP response packet is a packet returned by a server to the NPE in response to the HTTP request packet;
determining, by the NPE, whether a redirection packet is to be established for the HTTP response packet based on the HTTP response packet and a preset detection condition;
establishing, by the NPE, a redirection packet corresponding to the HTTP response packet based on the HTTP response packet when determining that a redirection packet is to be established for the HTTP response packet; and
sending, by the NPE, the redirection packet to the client in the chunked transmission manner.

2. The method according to claim 1, wherein restricting the transmission manner of the HTTP response packet corresponding to the HTTP request packet as the chunked transmission manner comprises:
searching, by the NPE, a header field name in a response header of the HTTP response packet for a first field name; and
when the first field name is found in the header field name in the response header of the HTTP response packet,
changing, by the NPE, the first field name in the header field name into a second field name, and
changing, by the NPE, a value corresponding to the header field name into a value corresponding to the second field name.

3. The method according to claim 2, further comprising:
searching, by the NPE, the header field name in the response header for a second field name when the first field name is not found in the header field name in the response header of the HTTP response packet; and
restricting, by the NPE, the transmission manner of the HTTP response packet as the chunked transmission manner when the second field name is found in the header field name in the response header.

4. The method according to claim 1, further comprising:
acquiring, by the NPE, a detection condition list, wherein the detection condition list comprise one or more preset detection conditions, and each of the preset detection conditions comprises a threshold of a packet size or a string of characters.

5. The method according to claim 4, wherein determining whether a redirection packet is to be established for the HTTP response packet comprises:
comparing, by the NPE, the HTTP response packet with the preset detection conditions in the detection condition list; and
determining, by the NPE, that a redirection packet is to be established for the HTTP response packet when the HTTP response packet matches at least one of the preset detection conditions.

6. The method according to claim 1, further comprising:
sending, by the NPE, the HTTP response packet to the client in the chunked transmission manner when determining that it is not necessary to establish a redirection packet for the HTTP response packet.

7. The method according to claim 1, wherein establishing a redirection packet corresponding to the HTTP response packet based on the HTTP response packet comprises:
determining, by the NPE, a first URL based on the HTTP request packet, wherein the first URL is a URL address determined based on the HTTP request packet when receiving the HTTP request packet from the client;
comparing, by the NPE, the first URL with a URL address recorded in each redirection entry in a preset redirection list;
determining, by the NPE, a URL address recorded in a redirection entry in the preset redirection list of which the URL address matches the first URL as a second URL; and
establishing, by the NPE, the redirection packet according to the second URL.

8. A network protection equipment (NPE), comprising a processor, wherein the processor reads machine readable instructions corresponding to a control logic of transmitting a packet and stored in a non-volatile memory and executes the instructions in a memory to:
receive an HTTP request packet from a client;
restrict a transmission manner of an HTTP response packet corresponding to the HTTP request packet as a chunked transmission manner, wherein the HTTP response packet is a packet returned to the NPE by a server according to the HTTP request packet;
determine whether a redirection packet is to be established for the HTTP response packet based on the HTTP response packet and a preset detection condition;
establish a redirection message corresponding to the HTTP response packet based on the HTTP response packet when determining that a redirection packet is to be established for the HTTP response packet, and
send the redirection packet to the client in the chunked transmission manner.

9. The device according to claim 8, wherein when restricting the transmission manner of the HTTP response packet corresponding to the HTTP request packet as the chunked transmission manner, the machine readable instructions cause the processor to:
search a header field name in a response header of the HTTP response packet for a first field name; and
change the first field name in the header field name into a second field name and change a value corresponding to the header field name into a value corresponding to the second field name when the first field name is found in the header field name in the response header of the HTTP response packet.

10. The device according to claim 9, wherein the machine readable instructions cause the processor to:
search the header field name in the response header for the second field name when the first field name is not found in the header field name in the response header of the HTTP response packet; and
restrict the transmission manner of the HTTP response packet as the chunked transmission manner when the second field name is found in the header field name in the response header.
